(19) United States
(12) Patent Application Publication
(10) Pub. No.: US 2025/0111536 A1
(43) Pub. Date: Apr. 3, 2025

(54) SENSOR CALIBRATION USING A DYNAMIC PATTERN GENERATOR FOR IN-CABIN MONITORING SYSTEMS AND APPLICATIONS

(71) Applicant: NVIDIA Corporation, Santa Clara, CA (US)

(72) Inventors: Dae Jin KIM, San Jose, CA (US); Chun-Wei CHEN, San Jose, CA (US); Leon WANG, Richmond Hill (CA); Anshul JAIN, San Franciso, CA (US)

(21) Appl. No.: 18/477,203

(22) Filed: Sep. 28, 2023

(51) Int. Cl. G06T 7/80; H04N 17/00; H04N 23/90

(52) U.S. Cl. CPC G06T 7/80; H04N 17/002; G06T 2207/30204; G06T 2207/30268; H04N 23/90

(57) ABSTRACT

In various examples, one or more interior or occupant monitoring sensors may be calibrated using one or more display units (e.g., a projector, LED panel, laser robot, heads-up display) that can actively project or display a unique visual pattern and change one or more attributes of the patterns (e.g., shape, color, brightness, size, frame rate, perspective, etc.) without moving the one or more display units. The present techniques may be utilized to iteratively calibrate a sensor using a dynamic visual pattern with one or more visual attributes that vary from iteration to iteration, and/or to interleave different visual patterns in a common region of an overlapping field of view shared by multiple sensors.

### BACKGROUND

Autonomous and semi-autonomous vehicles rely on machine learning approaches—such as those using deep neural networks (DNNs)—to analyze images of an interior space (e.g., cabin, cockpit) of a vehicle or other machine. An Occupant Monitoring System (OMS) is an example of a system that may be used within a vehicle cabin to perform real-time assessments of occupant or operator presence, gaze, alertness, and/or other conditions. For example, OMS sensors (such as, but not limited to, RGB sensors, infrared (IR) sensors, depth sensors, cameras, and/or other optical sensors) may be used to track an occupant's or operator's gaze direction, head pose, and/or blinking. This gaze information may be used to determine a level of attentiveness of the occupant or operator (e.g., to detect drowsiness, fatigue, and/or distraction), and/or to take responsive action to prevent harm to the occupant or operator—e.g., by redirecting their attention to a potential hazard, pulling the vehicle over, and/or the like. For example, DNNs may be used to detect that an operator is falling asleep at the wheel, based on the operator's downward gaze toward the floor of the vehicle, and the detection may lead to an adjustment in the speed and direction of the car (e.g., pulling the vehicle over to the side of the road) or an auditory alert to the operator.

Occupant monitoring systems often rely on observations from multiple OMS sensors, which typically use their own coordinate systems. As a result, observations from different OMS sensors (e.g., body pose of an occupant) are often represented in different coordinate systems. In order to compare observations from different OMS sensors, the observations may be transformed into a common frame of reference, such as a vehicle rig coordinate system. In order to transform the observations, the OMS sensors may be calibrated to the common frame of reference and the calibration (e.g., extrinsic parameters representing sensor position and pose with respect to the common frame of reference) may be used to transform the observation to the common frame of reference.

One conventional calibration technique involves positioning detectable visual patterns with one or more fiducial markers in the fields of view of the OMS sensors. Each OMS sensor may observe a pattern (e.g., by generating an image of the pattern), and fiducial marker detection may be applied to attempt to detect the fiducial markers. Fiducial marker detection may fail for a variety of reasons, for example, if the pattern is not positioned substantially within the field of view of an OMS sensor, if the pattern is too small or positioned too far away from the OMS sensor, if the lighting is insufficient for the OMS sensor to capture a good observation of the pattern, if the pattern is positioned on a plane that deviates substantially from the image plane of the OMS sensor, and/or other reasons. If fiducial marker detection fails, conventionally, a technician would physically move the pattern—or print and position a new one—and rerun fiducial marker detection, repeating the process until fiducial marker detection succeeds. In some scenarios, the field of view of a particular OMS sensor is in location that is hard to reach or a location in which it is hard to position a pattern. As such, the calibration process may require extensive trial and error, resulting in a cumbersome and computationally wasteful calibration process. As such, there is a need for improved sensor calibration processes.

### SUMMARY

Embodiments of the present disclosure relate to sensor calibration using a dynamic pattern generator. Systems and methods are disclosed that iteratively calibrate a sensor using a dynamic visual pattern with one or more attributes that vary from iteration to iteration.

In contrast to conventional systems, such as those described above, one or more interior or occupant monitoring sensors may be calibrated using one or more display units (e.g., a projector, LED panel, laser robot, heads-up display) that can actively project or display a unique visual pattern and change one or more attributes of the patterns (e.g., shape, color, brightness, size, frame rate, perspective, etc.) without moving the one or more display units. The present techniques may be utilized to iteratively calibrate a sensor using a dynamic visual pattern with one or more visual attributes that vary from iteration to iteration, and/or to interleave different visual patterns in a common region of an overlapping field of view shared by multiple sensors.

In an example calibration process, one or more pattern generators comprising one or more display units are positioned within a scene (e.g., an interior of a vehicle) to display one or more dynamic visual patterns within a field of view of one or more sensors (e.g., an overlapping field of view shared by multiple sensors). Taking an example sensor layout comprising a driver monitoring system (DMS) camera in the steering column and an overhead OMS camera facing downwards with a field of view that includes one or more driver and/or passenger seats, the overlapping field of view may include some or all of the driver's seat. In some embodiments in which the one or more display units include an LED panel, one or more LED panels may be positioned on the back rest and/or seat cushion of the driver's seat and oriented toward the cameras such that the LEDs display a pattern that is visible in the overlapping field of view. In some embodiments in which the one or more display units include a projector, one or more projectors may be positioned on the dashboard, steering column, or seat cushion of the driver's seat, and oriented to project a pattern of light onto the driver's seat back rest and/or the driver's seat cushion, such that the pattern is visible in the overlapping field of view.

In some embodiments, each sensor (whether individually or in combination with one or more other sensors) may be iteratively calibrated using a dynamic visual pattern that varies one or more visual attributes from iteration to iteration in a calibration loop. In some embodiments, a display unit may temporally interleave different visual patterns in a common region of an overlapping field of view shared by multiple sensors during any particular iteration of the calibration loop. For example, one or more LED boards or projectors may be used to flash different patterns at different frame rates, for different durations, for different frames, and/or otherwise to target different sensors (e.g., operating at different frame rates). During each iteration, one or more new visual patterns may be projected, the sensor(s) may be used to generate observation(s) of the new visual pattern(s), each of the sensor(s) may be calibrated using fiducial marker detection and 3D reconstruction to determine extrinsic parameters for each sensor, and the computed extrinsic parameters may be validated by testing their accuracy (e.g., by comparing re-projected locations of detected fiducial marker(s) to ground truth 3D locations, or by comparing projected ground truth locations to 2D locations of the detected fiducial marker(s)). As such, a loop controller may test the accuracy of the computed extrinsic parameters against a threshold, and if the accuracy does not satisfy the threshold, the loop controller may trigger a subsequent iteration of the calibration loop. As such, the calibration loop may repeat until the accuracy of the calibration (the extrinsic parameters for one or more sensor) satisfies the threshold.

### BRIEF DESCRIPTION OF THE DRAWINGS

The present systems and methods for sensor calibration using a dynamic pattern generator are described in detail below with reference to the attached drawing figures, wherein:

FIG. 1 is a data flow diagram illustrating an example data flow through an example sensor calibration system, in accordance with some embodiments of the present disclosure;

FIG. 2 is an illustration of an example visual pattern illuminating panel, in accordance with some embodiments of the present disclosure;

FIG. 3 is an illustration of an example robotic visual pattern projector, in accordance with some embodiments of the present disclosure;

FIG. 4 is an illustration of an example heads-up display projector, in accordance with some embodiments of the present disclosure;

FIG. 5 is an illustration of an example placement of a dynamic visual pattern within an interior space of a vehicle, in accordance with some embodiments of the present disclosure;

FIG. 6 is an example illustration of projecting coordinates of a detected fiducial marker, in accordance with some embodiments of the present disclosure;

FIG. 7 is a flow diagram showing a method for calibrating one or more sensors, in accordance with some embodiments of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

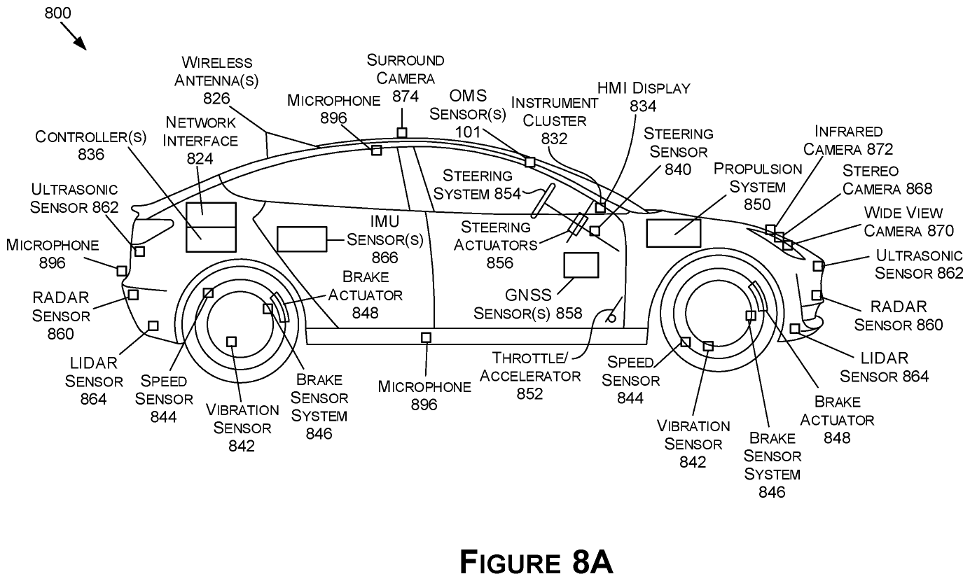

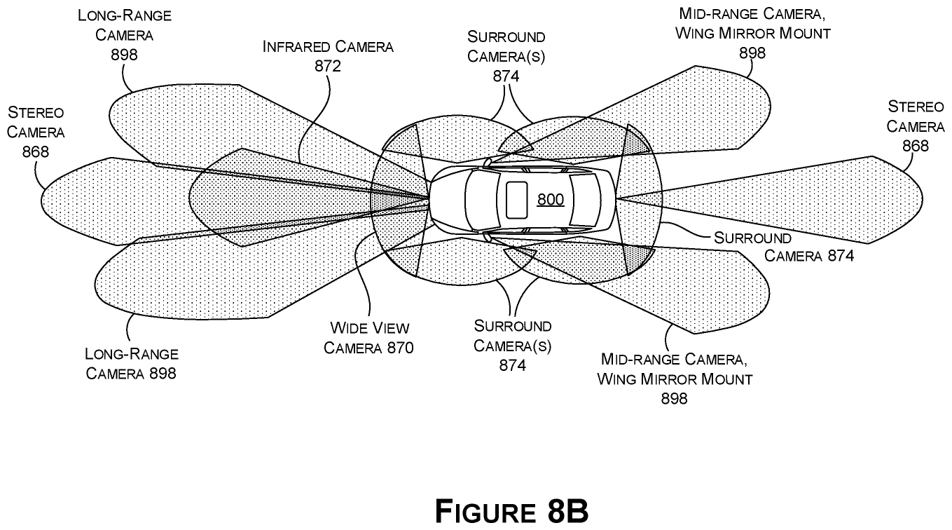

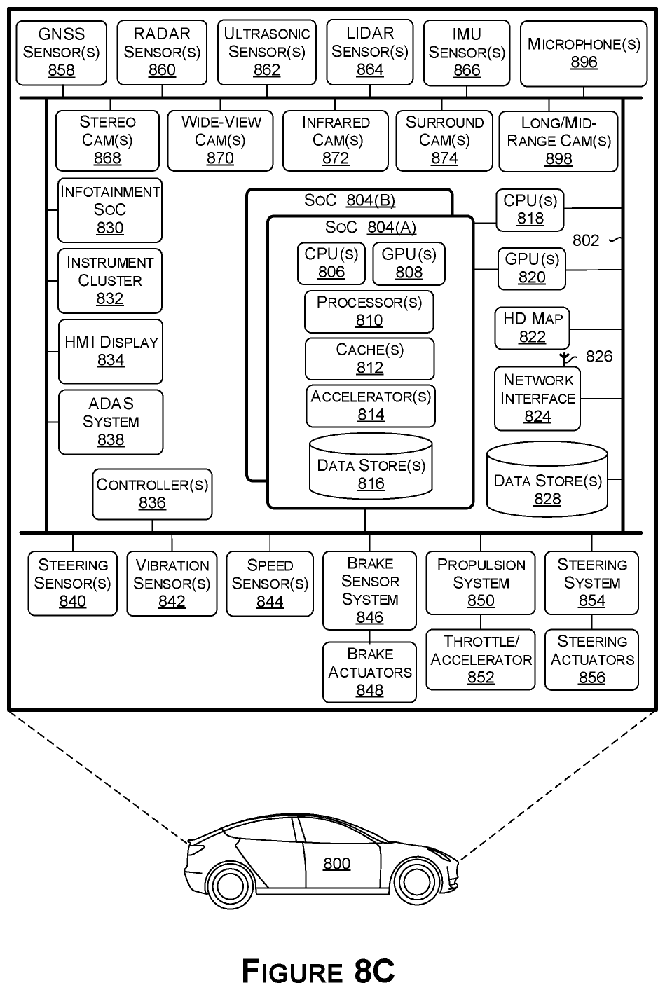

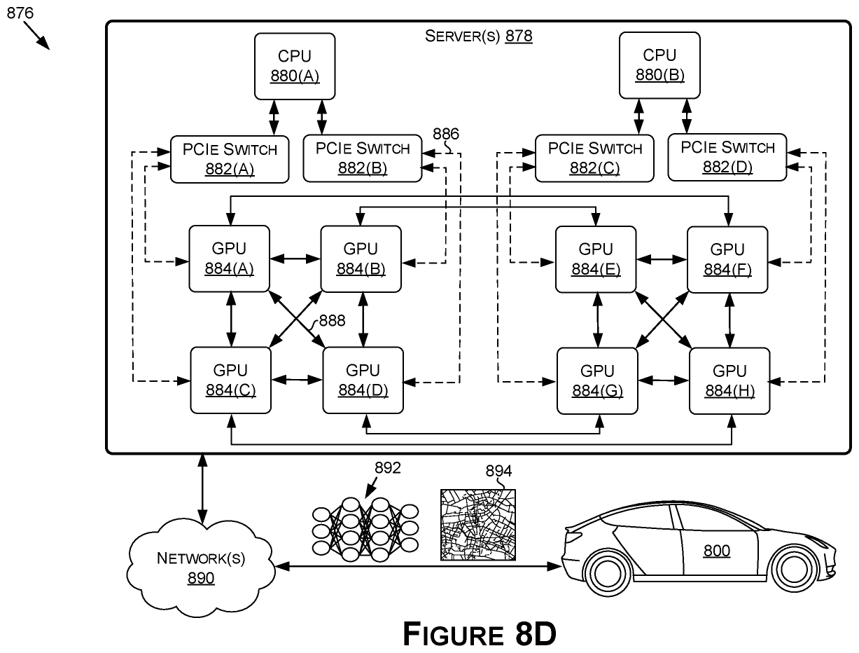

Systems and methods are disclosed related to sensor calibration using a dynamic pattern generator. Although the present disclosure may be described with respect to an example autonomous vehicle 800 (alternatively referred to herein as “vehicle 800” or “ego-vehicle 800,” an example of which is described with respect to FIGS. 8A-8D), this is not intended to be limiting. For example, the systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to calibrating sensors for an occupant monitoring system, this is not intended to be limiting, and the systems and methods described herein may be used in augmented reality, virtual reality, mixed reality, robotics, security and surveillance, autonomous or semi-autonomous machine applications, and/or any other technology spaces where sensor calibration may be used (e.g., calibrating sensors for interior spaces, such as rooms, warehouses, gymnasiums, containers, studios, etc.).

Systems and methods are disclosed that provide for calibrating interior or occupant monitoring sensors (e.g., a sensor of a camera, an RGB sensor, an Infrared sensor (IR), and/or a depth sensor or other optical sensor) using one or more display units (e.g., a projector, light emitting diode (LED) panel, laser robot, heads-up display) that can actively project or display a unique visual pattern and change one or more attributes of the patterns (e.g., shape, color, brightness, size, frame rate, perspective, etc.) without moving the one or more display units. The present techniques may be utilized to iteratively calibrate a sensor using a dynamic visual pattern with one or more visual attributes that vary from iteration to iteration, and/or to interleave different visual patterns in a common region of an overlapping field of view shared by multiple sensors. The present techniques may be utilized to calibrate sensors, such as an interior, in-cabin, or OMS sensor so that subjects observed within a shared field of view of the sensors may be analyzed in a common frame of reference.

In an example in-cabin or cockpit monitoring system such as a vehicle OMS, one or more optical sensors may be positioned to observe a scene within the cabin, cockpit, or other interior space. An OMS may comprise a DMS, a system that monitors non-driver occupants, or a system that monitors driver occupant(s) and/or non-driver occupant(s). Optical sensors (e.g., RGB sensors, infrared IR sensors, depth sensors, cameras, etc.) may be positioned and/or dispersed in a variety of ways. For example, a DMS camera may be positioned within a steering column, vehicle pillar, or infotainment console and oriented with its field of view facing toward the driver's seat. An OMS camera may be positioned overhead and oriented with a field of view facing down toward the front row of the vehicle and/or a back row of the vehicle. Generally, occupant and/or driver monitoring systems may include any number of cameras (e.g., 4 DMS cameras and 16 OMS cameras) positioned throughout a vehicle interior. These are just a few examples of possible sensor layouts, and other sensor layouts within any suitable scene may be implemented within the scope of the present disclosure.

In an example calibration process, one or more pattern generators comprising one or more display units are positioned within a scene (e.g., an interior of a vehicle) to display one or more dynamic visual patterns within a field of view of one or more sensors (e.g., an overlapping field of view shared by multiple sensors). Taking an example sensor layout comprising a DMS camera in the steering column and an overhead OMS camera facing down with a field of view that includes one or more driver and/or passenger seats, the overlapping field of view may include some or all of the driver's seat. In some embodiments in which the one or more display units include an LED panel, one or more LED panels may be positioned on the back rest and/or seat cushion of the driver's seat and oriented toward the cameras such that the LEDs display a pattern that is visible in the overlapping field of view. In some embodiments in which the one or more display units include a projector, one or more projectors may be positioned on the dashboard, steering column, or seat cushion of the driver's seat, and oriented to project a pattern of light onto the driver's seat back rest and/or the driver's seat cushion, such that the pattern is visible in the overlapping field of view.

In some embodiments, each sensor (whether individually or in combination with one or more other sensors) may be iteratively calibrated using a dynamic visual pattern that varies one or more attributes over time. For example, a first pattern may be displayed during a first iteration, upon which one or more target sensors may be used to capture a frame of sensor data representing the first pattern, and fiducial marker detection may be applied to detect one or more fiducial markers in the frame of sensor data from each of the target sensors. If fiducial marker detection is successful for a target sensor, extrinsic parameters for the target sensor may be determined using the detected fiducial marker(s). In some embodiments, the extrinsic parameters may be used to re-project the detected fiducial marker(s) into a ground truth 3D model representing the scene, and the accuracy of the re-projected detected fiducial marker(s) may be quantified by comparison to corresponding ground truth 3D locations. Depending on the embodiment, if fiducial marker detection fails and/or if the accuracy of the re-projected detected fiducial marker(s) is below a threshold, a dynamic pattern controller may cause the one or more display units to modify the pattern being displayed, upon which, the calibration process may be re-run (e.g., applying fiducial marker detection and/or testing the accuracy of re-projected detected fiducial marker(s)). The dynamic pattern controller may trigger any suitable change to any number of attributes of the pattern. For example, the dynamic pattern controller may vary one or more attributes (e.g., shape, color, brightness, size, frame rate, perspective) at a time while fixing other attributes, may select a value or instance of a given attribute (e.g., a particular shape or color) from a designated range of values or instances, may iterate through a designated range of values or instances sequentially or randomly, and/or otherwise. As such, a displayed pattern may be iteratively updated and the sensor(s) may be recalibrated using the updated pattern, for example, until some calibration completeness criterion is satisfied (e.g., a threshold accuracy of re-projected detected fiducial marker(s), designated number of iterations).

In some embodiments, a display unit may temporally interleave different visual patterns in a common region of an overlapping field of view shared by multiple sensors. For example, one or more LED boards or projectors may flash different patterns at different frame rates, for different durations, for different frames, and/or otherwise. Generally, different sensors (e.g., cameras) may use different resolutions, may view a common region from substantially different perspectives, and/or may have other characteristics, so different sensors may be better suited for different patterns. Since different sensors may use different operating frequencies (e.g., frame rates), interleaving different patterns using different frame rates or durations may permit different sensors to pick up different patterns. As such, the temporal interleaving of different visual patterns may effectively target different sensors with different patterns in the same location such that the different sensors may attempt to calibrate using different patterns during the same iteration.

As such, and more generally, a dynamic pattern controller may trigger iterative updates to a common visual pattern observed by multiple sensors until the calibration converges for any or all sensors, and/or may trigger iterative updates to different visual patterns observed by different sensors, using the same display unit(s). Iterative updates to different patterns may be synchronized (e.g., different updates for different patterns may be made for each iteration) and/or made independently of one another (e.g., updates may be made to any pattern for any iteration, for example, discontinuing iterative updates for one sensor once its calibration converges, but continuing iterative updates for another sensor running in the same calibration loop until its calibration converges, or updates to different patterns may run on different calibration loops).

As such, using techniques described herein, any number of interior or occupant monitoring sensors may be calibrated by iteratively updating a dynamic visual pattern, using the sensors to observe the dynamic visual pattern, running fiducial marker detection, and testing the accuracy of detected fiducial marker(s) until some calibration completeness criterion is met, without moving the display unit(s) that generate the dynamic visual pattern. The present techniques may be used to substantially simplify and reduce computational demands in the calibration process. For example, using the present techniques, a technician no longer needs to physically move the display units or print and position a new one when fiducial marker detection fails. Furthermore, iteratively varying different attributes of a visual pattern and/or interleaving different visual patterns in the same location improves the likelihood of successfully detecting fiducial markers, eases the detection process, reduces the number of iterations (and computational demands) that would otherwise be required, and/or reduces the number of display units needed when compared to prior techniques, benefits which are compounded the more sensors there are being calibrated. Finally, the present techniques reduce the need for technicians to engage in trial and error, particularly when attempting to calibrate sensors with fields of view covering locations that are hard to reach or in which it is hard to position a pattern, thereby simplifying the calibration process.

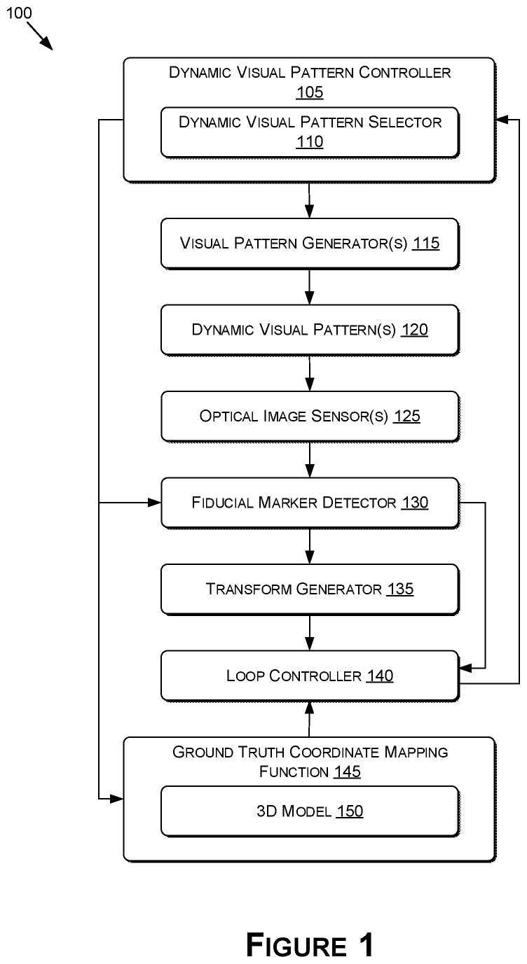

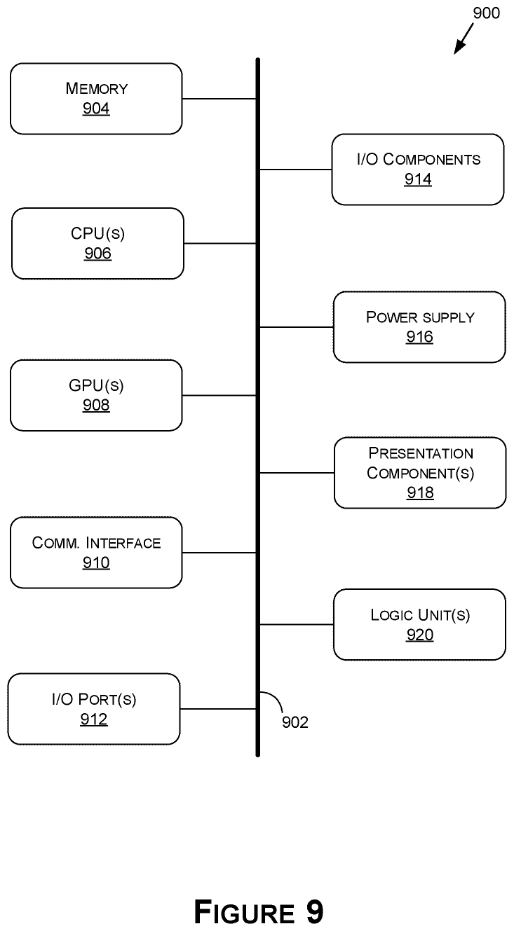

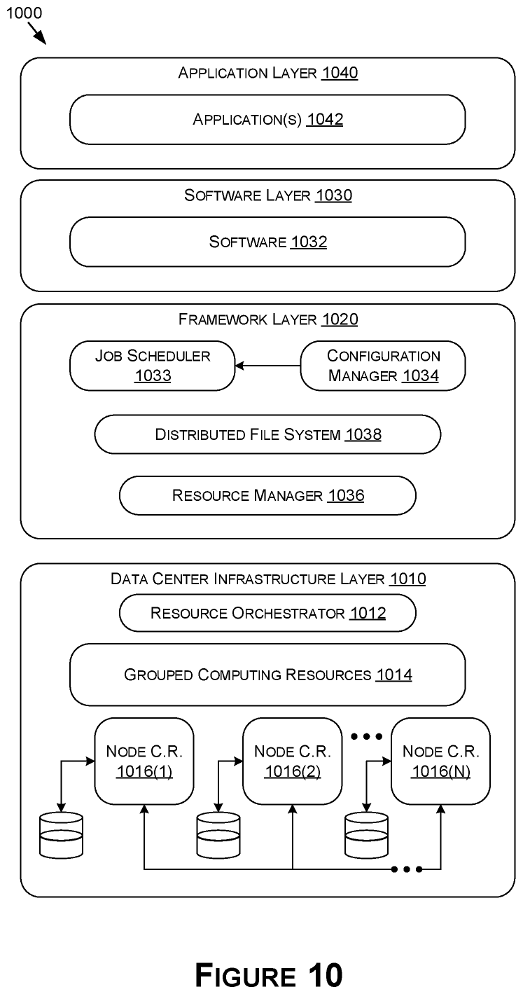

With reference to FIG. 1, FIG. 1 is a data flow diagram illustrating an example data flow through an example sensor calibration system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 800 of FIGS. 8A-8D, example computing device 900 of FIG. 9, and/or example data center 1000 of FIG. 10.

In the example illustrated in FIG. 1, the sensor calibration system 100 includes a dynamic visual pattern controller 105, a visual pattern generator(s) 115 configured to generate a dynamic visual pattern(s) 120, an optical image sensor(s) 125, a fiducial marker detector 130, a transform generator 135, a loop controller 140, and a ground truth coordinate mapping function 145. At a high level, the optical image sensor(s) 125 may include one or more interior, in-cabin, and/or OMS sensors positioned to observe a scene within a cabin, cockpit, or other interior space (e.g., an ego-object or machine such as the autonomous vehicle 800 of FIGS. 8A-8D), and the visual pattern generator(s) 115 may comprise one or more programmable display units positioned within the scene (e.g., an interior of a vehicle) to display the dynamic visual pattern(s) 120 within a field of view of the optical image sensor(s) 125 (e.g., an overlapping field of view shared by multiple sensors). The sensor calibration system 100 may operate in a loop to iteratively calibrate the optical image sensor(s) 125. For example, in any given iteration, the dynamic visual pattern controller 105 may select a visual pattern(s) from a plurality of supported visual patterns comprising fiducial marker(s) and provide a signal(s) representing the selected visual pattern(s) to the visual pattern generator(s) 115 (e.g., an LED panel, a robotic projector, a heads-up display), which, in response, displays a corresponding visual pattern(s) in the field of view the optical image sensor(s) 125. The displayed visual pattern(s) may be understood as a dynamic visual pattern(s) 120 because the dynamic visual pattern controller 105 may provide different signals that cause the visual pattern generator(s) 115 to display different visual patterns.

Once the dynamic visual pattern(s) 120 with the fiducial marker(s) is displayed, the optical image sensor(s) 125 may be used to generate an observation of the dynamic visual pattern(s) 120 (e.g., a frame of sensor data, such as an image, from each of the optical image sensor(s) 125). The fiducial marker detector 130 may apply fiducial marker detection to each observation to detect the presence of fiducial marker(s). In some embodiments, if the fiducial marker detector 130 does not detect a fiducial marker (e.g., within a threshold confidence) in a particular observation, the loop controller 140 may determine that a calibration completeness criterion is not satisfied and advance to the next iteration, triggering the dynamic visual pattern controller 105 to update the dynamic visual pattern(s) 120 and trigger the fiducial marker detector 130 to apply fiducial marker detection on a new observation of the updated dynamic visual pattern(s) 120.

In some embodiments, once the fiducial marker(s) are detected from an observation generated using a particular sensor of the optical image sensor(s) 125, the detected fiducial marker(s) may be used to calibrate the sensor. For example, the transform generator 135 may use the detected fiducial marker(s) to calculate extrinsic parameters for the sensor using 3D reconstruction (e.g., using any number of frames of sensor data from one or more optical image sensor(s) 125). In some embodiments, the loop controller 140 may use the calculated extrinsic parameters to re-project the detected fiducial marker(s) into a ground truth 3D model representing the scene and compare the accuracy of the 3D location(s) of the re-projected detected fiducial marker(s) to corresponding ground truth 3D locations of the fiducial marker(s) calculated by the ground truth coordinate mapping function 145. Additionally or alternatively, the loop controller 140 may use the extrinsic parameters to project the ground truth 3D locations of the fiducial marker(s) calculated by the ground truth coordinate mapping function 145 into the frame of sensor data (e.g., an image) from which the fiducial marker(s) was detected and compare the accuracy of the 2D location(s) of the projected ground truth fiducial marker(s) to the 2D location(s) of the detected fiducial marker(s). If the loop controller 140 determines the accuracy of the detected fiducial marker(s) is not within some threshold, the loop controller 140 may determine that a calibration completeness criterion is not satisfied (e.g., for one or more of the optical image sensor(s) 125) and advance to the next iteration, triggering the dynamic visual pattern controller 105 to update the dynamic visual pattern(s) 120 and trigger a re-calibration of the optical image sensor(s) 125 using the updated dynamic visual pattern(s) 120. As such, the sensor may be iteratively calibrated until the loop controller 140 determines that a calibration completeness criterion is satisfied.

In some embodiments, the dynamic visual pattern controller 105 may control the visual pattern generator(s) 115 by providing a signal that causes the visual pattern generator(s) 115 to display a visual pattern selected by the dynamic visual pattern selector 110. Generally, any number of visual patterns may be supported. For example, the visual pattern selected by the dynamic visual pattern selector 110 and displayed by the visual pattern generator(s) 115 may include one or more fiducial markers (e.g., a visual pattern formed by one or more LEDs or beams of light, such as an ARtag, an AprilTag, a QR code, a pattern of one or more points or shapes, etc.) that localize and facilitate determining a 3D position and orientation of the detected fiducial marker(s) with respect to the common 3D coordinate system using 3D reconstruction. In some embodiments, a visual pattern may arrange fiducial markers in an array, grid, or layout with a plurality of regions (e.g., cells) within which corresponding fiducial markers may be displayed. Generally, any visual pattern that facilitates computing 3D position, orientation, and/or identity of fiducial markers may be used.

Generally, the visual pattern generator(s) 115 may comprise one or more programmable display units (e.g., a projector, LED panel, laser robot, heads-up display) that can actively project or display a unique visual pattern and/or change one or more attributes of the patterns (e.g., shape, color, brightness, size, frame rate, perspective, etc.) in response to a corresponding control signal from the dynamic visual pattern controller 105, without moving the one or more display units. For example, in some embodiments in which the visual pattern generator(s) 115 includes an LED panel, image projector, video projector, heads-up display, a point generator configured to project one or more beams of light (e.g., a laser pointer, a light source with multiple laser diodes), and/or the like, the dynamic visual pattern controller 105 may provide the visual pattern generator(s) 115 with an image or some encoded representation of a visual pattern to display. Additionally or alternatively, in some embodiments in which the visual pattern generator(s) 115 includes a robotic projector (e.g., a gimbal-mounted robotic laser or other projector), the signal may include a set of rotation coordinates (e.g., an azimuth and elevation) indicating a direction where the visual pattern generator(s) 115 should point to produce the projected visual pattern.

Depending on the embodiment, different types of programmable display units may be used to support changes to different types of visual attributes. For example, one or more LED panels, image projectors, video projectors, and/or heads-up displays may be used to display visual patterns of differing shape, color, brightness, size, and/or frame rate. In some embodiments, 3D motion may be emulated by changing the perspective from which a particular visual pattern is displayed (e.g., by generating a virtual representation of the visual pattern in a virtual 3D space, projecting the visual pattern through a 2D viewport, rotating the visual pattern in the 2D viewport), which may facilitate a particular sensor (e.g., camera) perceiving changes in the visual pattern as changes in depth or changes in 3D orientation. In some embodiments, a point generator (e.g., a light source with one or more laser diodes) may project a fixed color of light, but other visual attributes may be varied. For example, a robotic arm may be moved to change the position of a projected beam of light on a surface (e.g. by rotating the point generator to point in a different direction), to change the size of a projected beam of light on a surface (e.g., by moving the point generator closer to or farther from the surface), to change the pattern projected on a surface (e.g., by changing a path length of an interferometer to change a projected diffraction pattern), etc. In some embodiments, a multi-point generator (e.g., an array of laser pointers) may be used to project an array of spot beams (or some other shape), and the pattern of spot beams may be varied by selectively driving individual point sources, selectively moving individual point sources, moving an entire array of point sources, and/or otherwise.

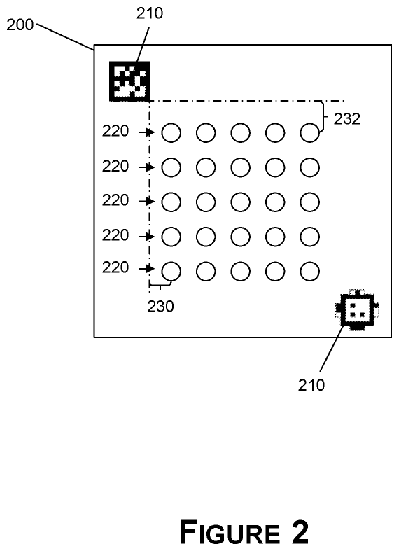

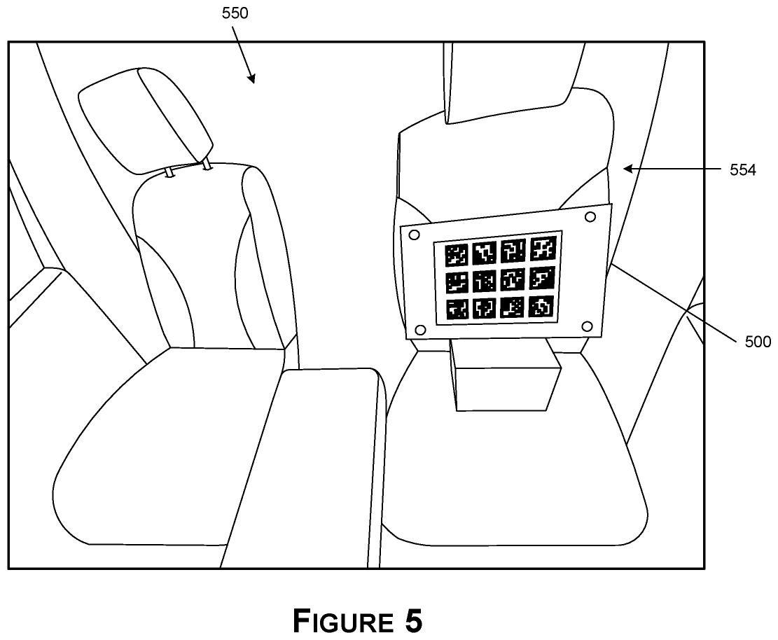

By way of example, FIGS. 2-4 illustrate some different types of visual pattern generator(s) 115, and FIG. 5 illustrates an example positioning of a visual pattern displayed by one or more pattern generator(s) 115. FIG. 2 is an illustration of an example visual pattern illuminating panel 200 (e.g., an LED panel), in accordance with some embodiments of the present disclosure. In this example, the visual pattern illuminating panel 200 includes illuminating devices 220 (e.g., LEDs) that may be selectively illuminated (e.g., by a corresponding drive signal from the dynamic visual pattern controller 105). In some implementations, a plurality of such visual pattern illuminating panels 200 may be positioned at various locations within an internal space such as a vehicle interior.

In this example, the visual pattern illuminating panel 200 includes fiducial markers 210 from which 3D coordinates (e.g., in a common coordinate system, such as an approximated rig coordinate system) for each of the illuminating devices 220 may be determined based on known offsets between an illuminating device 220 and a fiducial marker 210. For example, the visual pattern illuminating panel 200 may be placed at a designated region having known 3D coordinates (e.g., in the common coordinate system) such that the 3D coordinates of the fiducial markers 210 are also known. Using images of the fiducial markers 210, a pose computation algorithm (e.g., using the OpenCV algorithm solvePnP) may be used to compute a rotation-translation matrix that defines a rotation-translation transform describing the pose of the visual pattern illuminating panel 200 with respect to the common coordinate system. A horizontal offset 230 and a vertical offset 232 between the fiducial markers 210 and the one or more illuminating devices 220 may be known constants (e.g., based on the construction of the visual pattern illuminating panel 200) such that the 3D coordinates with respect to the common coordinate system for each of the illuminating devices 220 may be readily computed, for example, using 3D reconstruction and/or as a function of their offset from one of fiducial markers 210 and the established pose of the visual pattern illuminating panel 200.

In the example illustrated in FIG. 2, the visual pattern illuminating panel 200 includes a 5×5 array of illuminating devices 220 with 3D coordinates that may be reconstructed and/or computed based on known or reconstructed 3D coordinates of printed fiducial markers 210. As such, any given illuminating device 220 or combination of illuminating devices 220 may be used to form a fiducial marker (e.g., a fiducial marker which may be detectible by the fiducial market detector 130 of FIG. 1). For example, the entire array of illuminating devices 220 may form a single fiducial marker, the array may be divided into different regions and the illuminating devices 220 in each region may form a corresponding fiducial marker (e.g., a fiducial marker per region), and/or otherwise. Taking an ARtag, AprilTag, or QR code as an example type of fiducial marker, the array of illuminating devices 220 may be sized to generate an array or grid of fiducial markers (e.g., N×M unique patterns, such as a grid of AprilTags) across one or more visual pattern illuminating panels 200. Depending on the number and/or arrangement of illuminating devices 220, the illuminating devices 220 may be selectively illuminated to implement a variety of possible visual updates, such as changing a pattern for one or more fiducial markers (e.g., using a different ARtag, AprilTag, or QR code), changing color of one or more fiducial markers, changing brightness of one or more fiducial markers, resizing one or more fiducial markers (e.g., increasing or decreasing size), changing the layout of an array or grid of fiducial markers (e.g., reducing the number and/or arrangement of fiducial markers represented by the array of illuminating devices 220, for example, from subdividing the array into a 4×4 grid of fiducial markers to a 2×2 grid of fiducial markers, or a 2×2 grid to a 1×1 grid), changing a displayed perspective of one or more fiducial markers (e.g., rotating a virtual representation of one or more fiducial markers), changing a frame rate used to display one or more fiducial markers, and/or the like. In some embodiments in which the illuminating devices 220 are used to form multiple fiducial markers, updates to any particular fiducial marker may be made in sync with or independent of updates to the other fiducial marker(s).

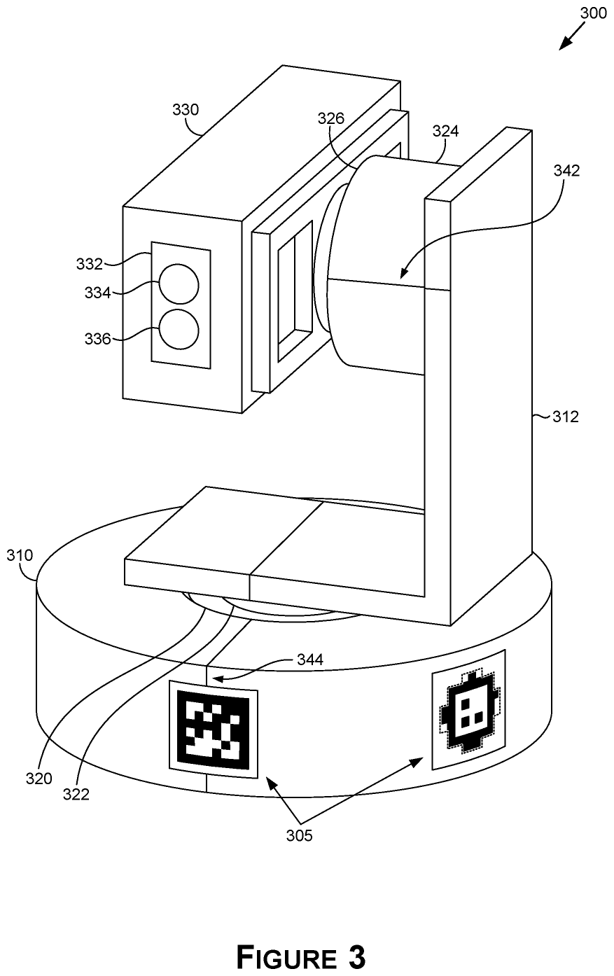

FIG. 3 is an illustration of an example robotic visual pattern projector 300, in accordance with some embodiments of the present disclosure. The robotic visual pattern projector 300 may comprise a mounting arm 312 rotatably coupled to a base 310 and/or rotatably coupled to a projector member 330. In some embodiments, the base 310 and mounting arm 312 form a set of gimbals for pivoting the projector member 330 with respect to a set of orthogonal pivot axes (e.g., an elevation axis and an azimuth axis). The base 310 and mounting arm 312 may be coupled via a first motor (e.g., an azimuth motor 320) to control the rotational position (e.g., the rotational orientation) of the projector member 330 with respect to the azimuth axis. In some embodiments, an azimuth motor encoder 322 tracks the position (and/or speed) of a motor shaft of the azimuth motor 320 to provide a closed loop feedback signal (e.g., to the dynamic visual pattern controller 105 of FIG. 1) for controlling and/or monitoring the rotation of the projector member 330 with respect to the azimuth axis. Similarly, the projector member 330 and mounting arm 312 may be coupled via a second motor (e.g., an elevation motor 324) to control the rotational position of the projector member 330 with respect to the elevation axis. In some embodiments, an elevation motor encoder 326 tracks the position (and/or speed) of a motor shaft of the elevation motor 324 to provide a closed loop feedback signal (e.g., to the dynamic visual pattern controller 105 of FIG. 1) for controlling and/or monitoring the rotation of the projector member 330 with respect to the elevation axis. In some embodiments, the azimuth motor encoder 322 may define an azimuth origin 344 (e.g., azimuth coordinate of zero degrees) for positioning the projector member 330 based on monitoring the motor shaft of the azimuth motor 320. Similarly, the elevation motor encoder 326 may define an elevation origin 342 (e.g., elevation coordinate of zero degrees) for positioning the projector member 330 based on monitoring the motor shaft of the elevation motor 324.

The projector member 330 may include a visual projection emitter 334 (e.g., one or more laser and/or LED devices, an image projector, video projector, etc.) which, when activated, generates a visual pattern on a target surface (e.g., in a vehicle interior) and/or supports a variety of possible visual updates, such as changing a pattern for one or more fiducial markers, changing color of one or more fiducial markers, changing brightness of one or more fiducial markers, resizing one or more fiducial markers, changing the layout or arrangement of (e.g., an array or grid of) fiducial markers, changing a displayed perspective of one or more fiducial markers, changing a frame rate used to display one or more fiducial markers, and/or the like. In some embodiments in which the visual projection emitter 334 is used to form multiple fiducial markers, updates to any particular fiducial marker may be made in sync with or independent of updates to the other fiducial marker(s). The projector member 330 may include a range finding sensor 336 (e.g., a laser range finder, an ultrasonic range finder) to determine a distance from the robotic visual pattern projector 300 to a target point where the projected visual pattern appears. The visual projection emitter 334 and range finding sensor 336 may be separate devices or at least partially integrated together as a visual projection emitter/range finding sensor 332 (e.g., such as a laser range finder that uses a visible laser).

In some embodiments, the base 310 (or some other portion) of the robotic visual pattern projector 300 may include one or more fiducial markers 305 (e.g., AprilTag patterns, ARtag patterns, and/or other patterns) that localize and facilitate determining a 3D position and orientation of the base 310 (e.g., the pose of the robotic visual pattern projector 300) with respect to a common coordinate system (e.g., a rig coordinate system). By generating an observation (e.g., an image) of the robotic visual pattern projector 300 and the one or more fiducial markers 305, a projector pose transform may be computed and used (e.g., by the ground truth coordinate mapping function 145 of FIG. 1) to translate rotation coordinates and projection depth data (e.g., generating using the range finding sensor 336) from 3D coordinates of the robotic visual pattern projector 300 to 3D coordinates of a common coordinate system.

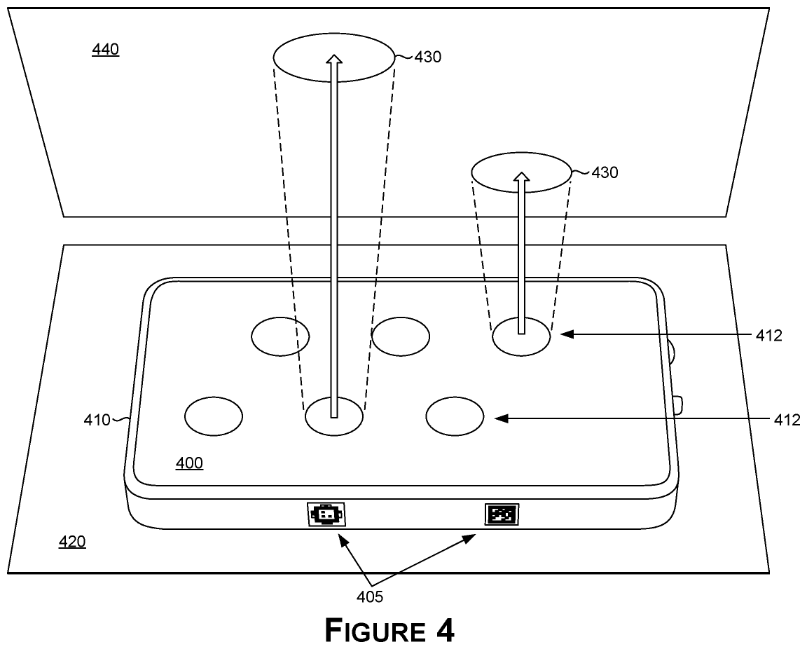

FIG. 4 is an illustration of an example heads-up display projector 400, in accordance with some embodiments of the present disclosure. In this example, the heads-up display projector 400 may be used to project a visual pattern comprising one or more fiducial markers 430 onto a target surface 440 (e.g., a surface in a field of view of one or more sensors). The heads-up display projector 400 may include a base that comprises one or more projection elements 412. When one or more projection elements 412 are activated, light emitted by those projection elements 412 may produce one or more projected fiducial markers 430 on the target surface 440. Similar to the robotic visual pattern projector 300, the projected fiducial markers 430 generated by the heads-up display projector 400 may be produced at projection points even where the target surface 440 is curved, small, or of irregular shape, as long as there is an unobstructed line of sight between the heads-up display projector 400 and the desired projection point. In some embodiments, the base 410 (or some other region) of the heads-up display projector 400 may include one or more fiducial markers 405 that localize and facilitate determining a 3D position and orientation of the base 410 of the heads-up display projector 400 with respect to a common coordinate system. In some embodiments, the heads-up display projector 400 may be an integrated component of a vehicle or machine, such as a heads-up projector used to display instrumentation readings or augmented reality images on a windshield, window, and/or other surface.

Similar to the robotic visual pattern projector 300, the 3D coordinates of projected fiducial markers 430 (e.g., in the common coordinate system) displayed by the heads-up display projector 400 may be precomputed based on: placement of the heads-up display projector 400 at a designated location on a surface 420 within the cabin, known distance (e.g., a known throw distance) from an activated projection element 412 to the target surface 440 on which the fiducial marker 430 is projected, and construction details of the heads-up display projector 400 (e.g., known offset(s) between the projection element(s) 412 producing the projected fiducial markers 430 and the one or more fiducial markers 405 on the base 410 of the heads-up display projector).

Similar to the robotic visual pattern projector 300, the heads-up display projector 400 may support a variety of possible visual updates, such as changing a pattern for one or more fiducial markers, changing color of one or more fiducial markers, changing brightness of one or more fiducial markers, resizing one or more fiducial markers, changing the layout or arrangement of (e.g., an array or grid of) fiducial markers, changing a displayed perspective of one or more fiducial markers, changing a frame rate used to display one or more fiducial markers, and/or the like. In some embodiments in which the heads-up display projector 400 is used to form multiple fiducial markers, updates to any particular fiducial marker may be made in sync with or independent of updates to the other fiducial marker(s).

Generally, one or more pattern generators (e.g., the visual pattern illuminating panel 200 of FIG. 2, the robotic visual pattern projector 300 of FIG. 3, the heads-up display projector 400 of FIG. 4, and/or some other image, video, or pattern projector) may be positioned within a scene (e.g., an interior of a vehicle) to display one or more dynamic visual patterns within a field of view of one or more sensors (e.g., an overlapping field of view shared by multiple sensors). FIG. 5 is an illustration of an example placement of a dynamic visual pattern within an interior space 550 of a vehicle, in accordance with some embodiments of the present disclosure. In FIG. 5, a visual pattern illuminating panel 500 is positioned on the back rest 554 of the driver's seat. This positioning may be used to display a visual pattern within an overlapping field of view shared by a DMS sensor (e.g., in the steering column or vehicle pillar) and an overhead OMS sensor (e.g., looking into the vehicle cabin from the rear-view mirror position). In this example, the visual pattern illuminating panel 500 (e.g., LED panel) is shown displaying a corresponding arrangement of fiducial markers (the non-illuminated LEDs are not illustrated). As such, the positioning of the visual pattern illuminating panel 500 and the fiducial markers displayed by the visual pattern illuminating panel 500 may be used to calibrate one or more sensors with respect to a common coordinate system (e.g., an approximated rig coordinate system). Note this pattern and fiducial marker layout (e.g., using a single pattern generator displaying a grid of fiducial markers) is meant simply as an example, and other implementations may use any number of pattern generators located in various positions.

Returning now to FIG. 1, the dynamic visual pattern controller 105 may include a dynamic visual pattern selector 110 configured to select, provide, and/or encode a representation a particular visual pattern (comprising one or more fiducial markers) from a plurality of supported visual patterns. For example, the dynamic visual pattern selector 110 may be coupled to a database that stores, and/or programmed to generate, a representation of different supported visual patterns; variable visual attributes; supported values, instances, and/or ranges of visual attributes; one or more selection criteria or procedures, and/or the like. For example, for each new iteration of a calibration loop (e.g., triggered by the loop controller 140), the dynamic visual pattern selector 110 may determine to change any number of attributes of the dynamic visual pattern(s) 120 (e.g., shape, color, brightness, size, frame rate) from iteration to iteration while fixing other visual attributes, may select a value or instance of a given attribute for a particular iteration (e.g., a particular shape or color) from a designated range of values or instances, may iterate through a designated range of values or instances sequentially or randomly from iteration to iteration, and/or otherwise.

In some embodiments, the dynamic visual pattern selector 110 may trigger the visual pattern generator(s) 115 to temporally interleave different visual patterns in a common region of an overlapping field of view shared by multiple sensors in a particular iteration. For example, the dynamic visual pattern selector 110 may generate and provide one or more signals that trigger one or more visual pattern generator(s) 115 (e.g., one or more LED boards or projectors) to flash different visual patterns at different frame rates, for different durations, for different frames, and/or otherwise.

As such, the dynamic visual pattern controller 105 may generate and provide a signal representing one or more visual patterns and/or one or more control signals to the visual pattern generator(s) 115 to control and cause the visual pattern generator(s) 115 to display the one or more visual patterns representing one or more fiducial markers. In some embodiments in which the dynamic visual pattern(s) 120 depend on one or more movable components (e.g., a robotic arm of the pattern generator(s) 115), the dynamic visual pattern controller 105 may determine that the one or more movable components have moved to a designated position (e.g., rotated to designated rotation coordinates) (e.g., based on feedback from the pattern generator(s) 115) prior to triggering the visual pattern generator(s) 115 to activate a visual projection emitter (e.g., a laser) to produce a visual pattern on a target surface and/or activating a range finding sensor to measure a distance (e.g., projection depth data) from the visual pattern generator(s) 115 to a point on the target surface where the visual pattern appears.

In some embodiments (e.g., upon triggering the visual pattern generator(s) 115 to display the one or more visual patterns), the dynamic visual pattern controller 105 may provide one or more control signals that trigger the optical image sensor(s) 125 to generate an observation(s) of the one or more visual patterns (e.g., a frame of sensor data, such as an image, from each of optical image sensor(s) 125). Upon generating the observation(s), one or more control signals may be generated (e.g., by the dynamic visual pattern controller 105, by code associated with the optical image sensor(s) 125) and provided to the fiducial marker detector 130 to trigger fiducial marker detection on the observation(s).

The fiducial marker detector 130 may take as input one or more observations of a visual pattern (e.g., whether using a single frame of sensor data representing the visual pattern, or multiple frames of sensor data), and may use any known technique to detect the presence of one or more fiducial markers in each observation. The fiducial marker detector 130 may execute or trigger one or more machine learning algorithms, deep neural networks, computer vison algorithms, image processing algorithms, mathematical algorithms, and/or other technologies, to determine whether the observation includes one or more fiducial markers and/or which portion of the observation includes the one or more fiducial markers. For example, the fiducial marker detector 130 (and/or other components such as the transform generator 135) may be implemented using any type of machine learning model or algorithm, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, long/short term memory/LSTM, Hopfield, Boltzmann, deep belief, deconvolutional, generative adversarial, liquid state machine, etc.), areas of interest detection algorithms, computer vision algorithms, and/or other types of algorithms or machine learning models.

In some embodiments, the fiducial marker detector 130 may determine the 2D coordinates of each detected fiducial marker(s) (e.g., within the image space of a frame of image data). Taking a frame of image data as an example, 2D coordinates u, v may be established for individual fiducial markers based on the location of the detected fiducial marker with respect to a horizontal u-axis and a vertical v-axis in image space. The 2D coordinates of a detected fiducial marker may be defined using one or more representative points of the detected fiducial marker (e.g., one or more corner points, a center point). In some embodiments, fiducial markers may embed within their pattern a notion of orientation from which the fiducial marker detector 130 may determine what point(s) on the fiducial markers is used to define its location.

In some embodiments, the fiducial marker detector 130 may determine 3D coordinates of each detected fiducial marker(s) in 3D coordinate system (e.g., a common 3D coordinate system shared by multiple optical image sensors 125), for example, using any known 3D reconstruction technique to recover 3D structure and/or one or more 3D points of the detected fiducial marker(s) (e.g., monocular depth estimation, triangulation, stereo vision, volumetric stereo, etc.). In some embodiments, the detected fiducial marker(s) (e.g., AprilTag patterns, ARtag patterns, and/or other patterns) localize and facilitate determining a 3D position and orientation of the detected fiducial marker(s) with respect to the common 3D coordinate system. In an example embodiment, the fiducial marker detector 130 may detect and determine 3D position and orientation of each detected fiducial marker relative to the position and orientation of the optimal image sensor 125 that captured the observation of that detected fiducial marker, thereby establishing a rotation-translation transform that maps the local coordinate system used by an individual optical image sensor 125 to a 3D coordinate system generated using 3D reconstruction. As such, the fiducial marker detector 130 may use different observations of the same detected fiducial marker generated using different optical image sensor(s) 125 to determine different rotation-translation transforms that map different local coordinate systems used by the different optical image sensor(s) 125 to a common 3D point on a detected fiducial marker. These relationships with a common 3D point may be used to orient the local coordinate systems relative to one another so they map into a common 3D coordinate system (which may approximate a rig coordinate system).

As such, for each detected fiducial marker, the fiducial marker detector 130 and/or the transform generator 135 may determine both a 2D coordinate (u, v) with respect to a 2D coordinate system (e.g., an image frame coordinate system) and a 3D coordinate (x, y, z) with respect to a 3D coordinate system (e.g., a rig coordinate system). Using the pair of corresponding 2D coordinates (u, v) and 3D coordinates (x, y, z) for a detected fiducial marker and the sensor intrinsic parameters (e.g., focal length parameters fₓ and f_{y}, sensor principal point parameters u₀ and v₀ and/or optical distortion coefficient γ) for the corresponding optical image sensor 125 used to generate the observation, the transform generator 135 may apply a transform computation that comprises a pose computation algorithm to compute one or more extrinsic parameters for the optical image sensor 125 (e.g., a rotation-translation transform). For example, the transform generator 135 may compute a rotation-translation transform as an RT matrix comprising a rotation vector (R) and translation vector (T), for example, using the following expression:

$$s [ \begin{matrix}u \\ v \\ 1\end{matrix} ] = [ \begin{matrix}{f}_{x} & s & {u}_{0} \\ 0 & {f}_{y} & {v}_{0} \\ 0 & 0 & 1\end{matrix} ] [ R \vert T ] [ \begin{matrix}x \\ y \\ z \\ 1\end{matrix} ]$$

where (x, y, z) are the coordinates of a 3D point in a 3D coordinate system, (u, v) are coordinates of the 3D point in pixel units, fₓ and f_{y} are focal lengths of the optical image sensor 125 in pixel units, u₀ and v₀ is the principal point of the optical image sensor 125, and s is a skew coefficient that transforms the projection based on a skew between x and y axes of the image plane.

Although the rotation-translation transform may be computed using a single detected fiducial marker's pair of corresponding 2D coordinates and 3D coordinates, greater accuracy may be achieved by optimizing 2D-3D coordinate pairs for a plurality of detected fiducial markers (e.g., three, five, some larger number). For example, in some embodiments, the pose computation algorithm iteratively computes the RT matrix to converge on a set of R and T values that fit the 2D and 3D coordinates of the set of coordinate pairs of detected fiducial markers. In this way, the pose computation algorithm may compute an (e.g., optimized) translation-rotation matrix corresponding to the extrinsic pose of each optical image sensor 125. The OpenCV algorithm solvePnP is one example of a pose computation algorithm that may be applied to estimate rotation (R) and translation (T) vectors to derive the rotation-translation transform.

In some embodiments, the accuracy of the estimated extrinsic parameter(s) (e.g., a rotation-translation transform) computed by the transform generator 135 may be quantified (e.g., by the loop controller 140 and/or the ground truth coordinate mapping function 145) and used to determine whether to initiate a successive calibration iteration. For example, a 3D representation (e.g., 3D model) of the visual pattern generator(s) 115 and/or the dynamic visual pattern(s) 120 may be placed in a ground truth 3D model 150 representing the scene (e.g., a 3D model of a vehicle interior) using an estimated position and orientation corresponding to the physical placement in the scene. Accordingly, the dynamic pattern controller 105 may provide the ground truth coordinate mapping function 145 with a representation of the dynamic visual pattern(s) 120 and/or its constituent fiducial marker(s) used during a particular iteration, and the ground truth coordinate mapping function 145 may determine ground truth 3D locations for the corresponding detected fiducial marker(s) in the 3D model 150 based on known geometries of the visual pattern generator(s) 115, dynamic visual pattern(s) 120, and/or the scene. As such, the loop controller may re-project the detected fiducial marker(s) into the ground truth 3D model (or project the ground truth 3D locations into the observation of the detected fiducial marker(s)) and compare the location(s) of the detected fiducial marker(s) to the known ground truth locations. If the difference exceeds some calibration completeness criterion (e.g., a threshold 2D or 3D distance, pixel separation, etc.), the loop controller 140 may determine to—and initiate—a successive calibration iteration (e.g., for a particular sensor, for a group of sensors). Otherwise (e.g., the calibration completeness criterion is satisfied), the loop controller 140 may terminate the calibration loop (e.g., for a particular sensor, for a group of sensors).

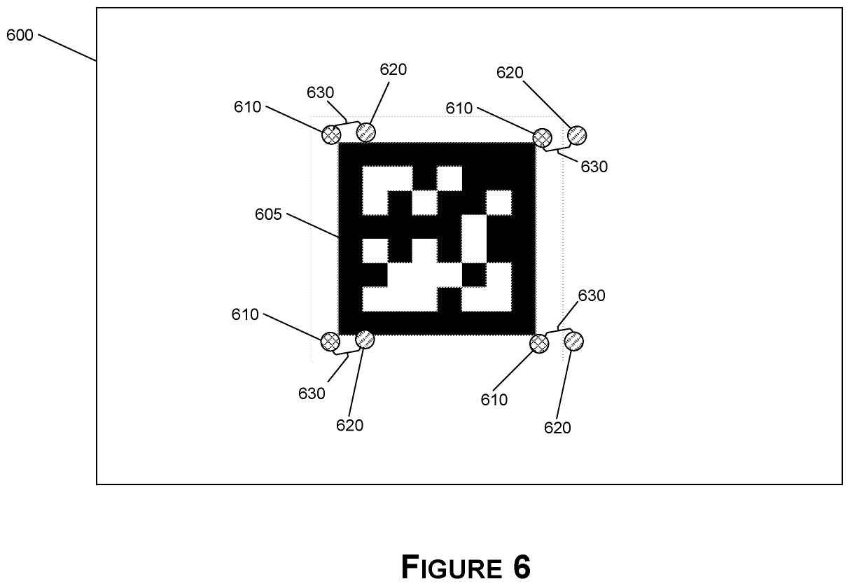

FIG. 6 is an example illustration of projecting coordinates of a detected fiducial marker, in accordance with some embodiments of the present disclosure. In FIG. 6, one or more corners of given fiducial marker 605 may define one of more calibration points 610. The 3D coordinates (xᵢ, yᵢ, zᵢ) for these calibration points 610 of the fiducial marker 605 may be known coordinates with respect to a shared 3D coordinate system (e.g., determining using 3D reconstruction). Using an image frame 600 captured by an optical image sensor, and a rotation-translation transform computed for that sensor (e.g., the transform generator 135 of FIG. 1), 2D validation points 620 (e.g., each corresponding to one of the calibration points 610) may be computed and projected into the image frame 600. The 2D coordinates of the computed validation points 620 may be compared to the 2D coordinates of the corresponding calibration points 610 that are derived from the captured image frame 600. The deviations 630 between the coordinates of the validation points 620 and the coordinates of the calibration points 610 captured in the image frame 600 may indicate a calibration error in the rotation-translation transform computed by the transform generator 135 and, as such, may be compared to a threshold. In some embodiments, calibration errors computed for a plurality of fiducial markers 620 from the captured image frame 600 may similarly be determined and an aggregate calibration accuracy metric computed and may be compared to a threshold.

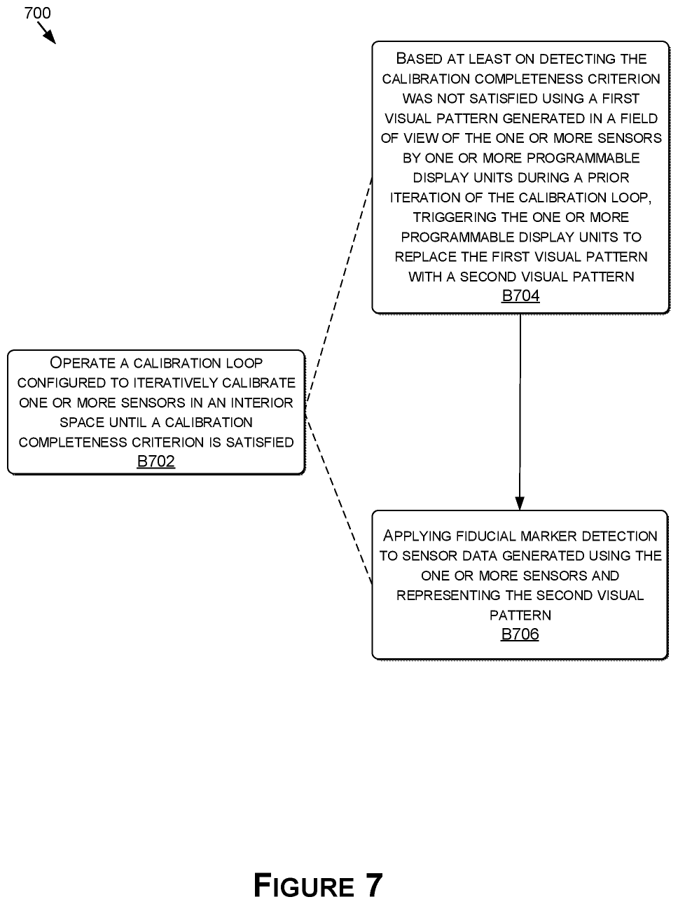

Now referring to FIG. 7, each block of method 700, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, the method 700 is described, by way of example, with respect to the sensor calibration system 100 of FIG. 1. However, this method may additionally or alternatively be executed by any one system, or any combination of systems, including, but not limited to, those described herein.

FIG. 7 is a flow diagram showing a method 700 for calibrating one or more sensors, in accordance with some embodiments of the present disclosure. The method 700, at block B702, includes operating a calibration loop configured to iteratively calibrate one or more sensors in an interior space until a calibration completeness criterion is satisfied. For example, with respect to FIG. 1, the sensor calibration system 100 may operate in a loop to iteratively calibrate the optical image sensor(s) 125. The calibration completeness criterion may include a determination that a detected fiducial marker(s) has a threshold accuracy (e.g., a threshold 2D or 3D distance or pixel separation between the detected fiducial marker(s) and a corresponding ground truth fiducial marker(s), a designated number of iterations).

The method 700, at blocks B704-B706, represent one possible way of performing at least a portion of an iteration of the calibration loop operated in block B702. The method 700, at block B704, includes, based at least on detecting the calibration completeness criterion was not satisfied using a first visual pattern generated in a field of view of the one or more sensors by one or more programmable display units during a prior iteration of the calibration loop, triggering the one or more programmable display units to replace the first visual pattern with a second visual pattern. For example, with respect to FIG. 1, the loop controller 140 may determine that a calibration completeness criterion is not satisfied during the prior iteration based on an indication that the fiducial marker detector 130 did not detect (e.g., within a threshold confidence) a fiducial marker generated by the visual pattern generator(s) 115 as part of a dynamic pattern(s) 120, and/or based on the loop controller 140 determining the accuracy of a detected fiducial marker(s) is not within some threshold (e.g., a threshold 2D or 3D distance or pixel separation between the detected fiducial marker(s) and a corresponding ground truth fiducial marker(s)). Accordingly, the loop controller 140 may determine to advance to the next iteration, triggering the dynamic visual pattern controller 105 to update the dynamic visual pattern(s) 120 and trigger the fiducial marker detector 130 to apply fiducial marker detection on a new observation of the updated dynamic visual pattern(s) 120. In some embodiments, for each new iteration (e.g., triggered by the loop controller 140), the dynamic visual pattern selector 110 may determine to change any number of attributes of the dynamic visual pattern(s) 120 (e.g., shape, color, brightness, size, frame rate) at a time while fixing other visual attributes, may select a value or instance of a given attribute (e.g., a particular shape or color) from a designated range of values or instances, may iterate through a designated range of values or instances sequentially or randomly, and/or otherwise. In some embodiments, the dynamic visual pattern selector 110 may trigger the visual pattern generator(s) 115 to temporally interleave different visual patterns in a common region of an overlapping field of view shared by multiple sensors.

The method 700, at block B706, includes applying fiducial marker detection to sensor data generated using the one or more sensors and representing the second visual pattern. For example, with respect to FIG. 1, the fiducial marker detector 130 may apply fiducial marker detection on an observation of the updated dynamic visual pattern(s) 120 and/or reconstruct a 3D location of one or more detected fiducial marker(s). For each detected fiducial marker, the transform generator 135 may apply a transform computation that comprises a pose computation algorithm to compute one or more extrinsic parameters for the optical image sensor 125 used to generate the observation (e.g., the transform generator 135 may attempt to calibrate the sensor) using the reconstructed 3D location(s) of the detected fiducial marker(s). In some embodiments, the accuracy of the estimated extrinsic parameter(s) (e.g., a rotation-translation transform) computed by the transform generator 135 may be quantified (e.g., by the loop controller 140 and/or the ground truth coordinate mapping function 145) and used to determine whether to initiate a successive calibration iteration.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Autonomous Vehicle

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1-Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LIDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), one or more occupant monitoring system (OMS) sensor(s) 801 (e.g., one or more interior cameras), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may be any number (including zero) of wide-view cameras 870 on the vehicle 800. In addition, any number of long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

Any number of stereo cameras 868 may also be included in a front-facing configuration. In at least one embodiment, one or more of stereo camera(s) 868 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

Cameras with a field of view that include portions of the interior environment within the cabin of the vehicle 800 (e.g., one or more OMS sensor(s) 801) may be used as part of an occupant monitoring system (OMS) such as, but not limited to, a driver monitoring system (DMS). For example, OMS sensors (e.g., the OMS sensor(s) 801) may be used (e.g., by the controller(s) 836) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to enable gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LIDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 812 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LIDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LIDAR sensor(s) 864. The LIDAR sensor(s) 864 may be used for object and pedestrian detection, emergency braking, collision avoidance, and/or other functions. The LIDAR sensor(s) 864 may be functional safety level ASIL B. In some examples, the vehicle 800 may include multiple LIDAR sensors 864 (e.g., two, four, six, etc.) that may use Ethernet (e.g., to provide data to a Gigabit Ethernet switch).

In some examples, the LIDAR sensor(s) 864 may be capable of providing a list of objects and their distances for a 360-degree field of view. Commercially available LIDAR sensor(s) 864 may have an advertised range of approximately 800 m, with an accuracy of 2 cm-3 cm, and with support for a 800 Mbps Ethernet connection, for example. In some examples, one or more non-protruding LIDAR sensors 864 may be used. In such examples, the LIDAR sensor(s) 864 may be implemented as a small device that may be embedded into the front, rear, sides, and/or corners of the vehicle 800. The LIDAR sensor(s) 864, in such examples, may provide up to a 120-degree horizontal and 35-degree vertical field-of-view, with a 200 m range even for low-reflectivity objects. Front-mounted LIDAR sensor(s) 864 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 800. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include a SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LIDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 800), while the I2V communication concept provides information about traffic further ahead. CACC systems may include either or both I2V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(H) (collectively referred to herein as PCIe switches 882), and/or CPUs 880(A)-880(B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1033, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1033 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1033. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more processing units to operate a calibration loop to iteratively calibrate one or more sensors in an interior space until a calibration criterion is satisfied, an iteration of the calibration loop including:
based at least on detecting the calibration criterion was not satisfied using a first visual pattern generated in a field of view of the one or more sensors by one or more programmable display units during a prior iteration of the calibration loop, triggering the one or more programmable display units to replace the first visual pattern with a second visual pattern; and
applying fiducial marker detection to sensor data generated using the one or more sensors and corresponding to the second visual pattern.

2. The processor of claim 1, wherein the one or more sensors comprise multiple sensors, the one or more processing units further to trigger iterative updates to a common visual pattern observed by the multiple sensors and generated by the one or more programmable display units during successive iterations of the calibration loop until the calibration criterion is satisfied for at least one of the multiple sensors.

3. The processor of claim 1, wherein the one or more sensors comprise multiple sensors, the one or more processing units further to trigger one or more iterative updates to different visual patterns observed by the multiple sensors and generated by the one or more programmable display units during successive iterations of the calibration loop until the calibration criterion is satisfied for at least one of the multiple sensors.

4. The processor of claim 1, wherein the one or more sensors comprise multiple sensors, the one or more processing units further to trigger the one or more programmable display units to interleave different visual patterns in a common region of an overlapping field of view shared by the multiple sensors.

5. The processor of claim 1, the one or more processing units further to trigger the one or more programmable display units to generate different visual patterns using different frame rates, for different durations, or for different frames during the iteration of the calibration loop.

6. The processor of claim 1, wherein the one or more sensors comprise multiple sensors, the one or more processing units further to trigger the one or more programmable display units to target different sensors of the multiple sensors with different visual patterns in an overlapping field of view shared by the multiple sensors, and calibrate the different sensors using the different visual patterns during the iteration of the calibration loop.

7. The processor of claim 1, wherein the calibration criterion comprises a determination that an accuracy of one or more re-projected fiducial markers detected by the fiducial marker detection satisfies a threshold.

8. The processor of claim 1, the one or more processing units further to trigger the one or more programmable display units to iterate through a range of values or instances of visual attributes of supported visual patterns during successive iterations of the calibration loop.

9. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

10. A system comprising:
one or more processing units to trigger, based at least on detecting that a first iteration of a calibration procedure to calibrate one or more sensors in an interior space did not satisfy a calibration criterion, a subsequent iteration of the calibration procedure, the subsequent iteration causing one or more programmable display units to replace a first visual pattern displayed in a field of view of the one or more sensors during the first iteration with a second visual pattern.

11. The system of claim 10, wherein the one or more sensors comprise multiple sensors, the one or more processing units further to trigger iterative updates to a common visual pattern observed by the multiple sensors and generated by the one or more programmable display units during successive iterations of the calibration procedure until the calibration criterion is satisfied for at least one of the multiple sensors.

12. The system of claim 10, wherein the one or more sensors comprise multiple sensors, the one or more processing units further to trigger one or more iterative updates to different visual patterns observed by the multiple sensors and generated by the one or more programmable display units during successive iterations of the calibration procedure until the calibration criterion is satisfied for at least one of the multiple sensors.

13. The system of claim 10, wherein the one or more sensors comprise multiple sensors, the one or more processing units further to trigger the one or more programmable display units to interleave different visual patterns in a common region of an overlapping field of view shared by the multiple sensors.

14. The system of claim 10, the one or more processing units further to trigger the one or more programmable display units to generate different visual patterns using different frame rates, for different durations, or for different frames during the subsequent iteration of the calibration procedure.

15. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing deep learning operations;
a system for performing real-time streaming;
a system implemented using an edge device;
a system implemented using a robot;
a system incorporating one or more virtual machines (VMs);
a system implemented at least partially in a data center;
a system for performing light transport simulation;
a system for performing collaborative content creation for 3D assets;
a system for generating synthetic data; or
a system implemented at least partially using cloud computing resources.

16. A method comprising:
based at least on detecting that a first iteration of a calibration loop configured to calibrate one or more sensors in an interior space did not satisfy a calibration criterion, initiating a subsequent iteration of the calibration loop to:
cause one or more programmable display units to replace a first visual pattern displayed in a field of view of the one or more sensors during the first iteration with a second visual pattern;
apply fiducial marker detection to sensor data generated using the one or more sensors and representing the second visual pattern; and
determine whether the calibration criterion is satisfied based at least on the fiducial marker detection.

17. The method of claim 16, wherein the one or more sensors comprise multiple sensors, the method further comprising triggering the one or more programmable display units to target different sensors of the multiple sensors with different visual patterns in an overlapping field of view shared by the multiple sensors, and determining one or more calibration parameters for the different sensors using the different visual patterns during the subsequent iteration of the calibration loop.

18. The method of claim 16, wherein the calibration completeness criterion comprises a determination that an accuracy of one or more re-projected fiducial markers detected by the fiducial marker detection satisfies a threshold.

19. The method of claim 16, further comprising triggering the one or more programmable display units to iterate through a range of values or instances of visual attributes of supported visual patterns during successive iterations of the calibration loop.

20. The method of claim 16, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
